(19) United States
(12) Patent Application Publication
(10) Pub. No.: US 2001/0013020 A1
(43) Pub. Date: Aug. 9, 2001

(54) Service providing system and method used therefor

(76) Inventors: Hiroshi Yoshida, Tokyo (JP); Yoshihito Kurose, Kyoto-city (JP); Eiichi Miyahiro, Kyoto-city (JP)

Correspondence Address: Mr. Michael D. Bednarek, SHAW PITTMAN, 2300 N STREET, N.W., WASHINGTON, DC, 20037-1128, US

(21) Appl. No.: 09/761,756

(22) Filed: Jan. 18, 2001

(30) Foreign Application Priority Data
Jan. 20, 2000 (JP) 2000-012173 (P)

(51) Int. Cl. G06F 17/60

(52) U.S. Cl. 705/50

(57) ABSTRACT

The present invention provides a service providing system capable of protecting confidential information on the users and preventing illegal use of the information. Input of ID, and password is required by a user verification device 22 as a result of performing redirect processing when a user terminal 16 try to access with a web 30 providing a pay-service. Upon entering proper ID and password, the user verification device 22 issues an access ticket. The user terminal 16 accesses the web 30 with the access ticket and receives a service therefrom. The user verification device 22 transmits information on the user to a charge-processing device 24, and the device 24 performs charge-processing. In this way, management of accessing with the web and charging a service charge(s) can be performed without disclosing confidential information such as password and so on to the administrator of service providing webs.

### CROSS REFERENCE TO RELATED APPLICATIONS

All the contents disclosed in Japanese Patent Application No. H12-012173 (filed on Jan. 25, 2000), including specification, claims, drawings and abstract and summary are incorporated herein by reference in its entirety.

### BACKGROUND OF THE INVENTION

1. Field of the Invention

This invention relates to a service providing system, which provides services over network such as the Internet, and, more particularly, to the system enabling protects of confidential information on the users, and preventing illegal use of the information.

2. Description of the Related Art

FIG. 1 shows a conventional service providing system using the Internet. In the system, a user terminal 2 can access to a service-providing web 6 via the Internet 4. In order to receive a service provided by the web 6, the user of the terminal need to transmit a registered ID and a password to the web. The web 6 refuses to provide its service to the terminal 2 if the ID or the password being transmitted therefrom is not authentic, else the web 6 provides its service thereto.

Thus, only the user(s) who has been registered to the web 6 can receive its service therefrom. Similar procedures are required to the remaining service-providing webs 8 and 10. In other words, the user can receive a service from only the web that accepts his/her registration. In this way, each of the service providing webs can realize pay-service.

However, the conventional system has the following problems to solve.

The user of the system tends to use a common password for each of the webs 6, 8, and 10 for simplicity.

Assuming that the web 8 is owned by a service provider who has an intention abusive use of information collected by the web. In such case, the owner of the web 8 can obtain the user ID and his/her password as a result of the access performed by the user. By the use of the ID and the password, the owner of the web 8 may be pass himself/herself off as the user of the webs 6 and 10 and access thereto.

In the case of using a mobile phone as the user terminal, either of its phone number or a subscriber identifier associated with the phone number is often used as the user ID thereof. In such case, the subscriber undesirably informs his/her phone number or subscriber identifier to the web owner through the access of the web. Since these information possibly be used by the owner who intend to use them illegal purposes, the user is anxious about the use of the system.

The possibility of illegal use of the information prevents the user from frequent use of the system, and there is fear that the growth of service providing webs would be disrupted.

### SUMMARY OF THE INVENTION

It is an object of the present invention to provide a service providing system capable of protecting confidential information on the users, and preventing illegal use of the information.

(1) In accordance with characteristics of the present invention, there is provided a service providing system comprising terminal devices capable of communicating one another through a network, a user verification device, and a service providing device including at least one service providing web,

wherein each of the terminal devices comprises;

verifying information transmission means for transmitting information for verification to the user verification device, and

service requesting means for requesting a service to the service providing web with an access ticket obtained from the user verification device,

and wherein the user verification device comprises;

user verification means for judging whether or not user of a terminal device is a registrant upon receipt of the information for verification from the terminal device, and

access ticket issuing means for transmitting an access ticket for accessing a service providing web to the terminal upon receipt of designation of a desired service providing web when the user verification means judges that the user of the terminal is a registrant, and

wherein the service providing web comprises;

access ticket judging means for judging whether or not a request for service accompanies the access ticket upon receipt of the request for service from the terminal device, and

service providing means for providing a service to the terminal device when the access ticket judging means judges that the request for service accompanies the access ticket, and

wherein following procedure is performed when the terminal device receives the service from the service providing web;

the information for verification is transmitted by the verifying information transmission means of the terminal device,

the user verification means of the user verification device judges whether or not the user of the terminal device is a registrant in accordance with the information for verification, and the access ticket for the service providing web is transmitted to the terminal device when the user is a registrant,

the service requesting means of the terminal device requests the service to the service providing web with the access ticket, and

the service providing web provides the service after confirming accompany of the access ticket.

In this way, information for verification is provided to the user verification device and no such information is provided directly to the service providing web. The user verification device issues an access ticket allowing access to the service providing web after confirming the information for verification. Consequently, management of accessing with the web can be carried out without disclosing the information for verification.

(2) Also, in accordance with characteristics of the present invention, there is provided a service providing system for providing a service to a user terminal device through a network, the system comprising a user verification device and a service providing device including at least one service providing web,

wherein the user verification device judges whether or not a user of the user terminal device is a registrant and transmits an access ticket for accessing a service providing web to the terminal upon receipt of designation of a desired service providing web when the user verification means judges that the user of the terminal is a registrant, and

wherein the service providing web judges whether or not a request for service accompanies the access ticket upon receipt of the request for service from the terminal device and provides a service to the terminal device when the service providing web judges that the request for service accompanies the access ticket.

(3) The service providing system according to the present invention is characterized in that the user verification device manages the information for verification for each of the service providing webs and controls issuance of the access ticket related to each of the service providing webs.

In this way, the system can be developed without awareness of the user verification device separately provided from service providing device to the user because management of the information is performed each of the service providing webs.

(4) Also, the service providing system according to the present invention is characterized in that the user verification device manages common information for verification in relation to a plurality of service providing webs and controls issuance of the access ticket related to each of the service providing webs.

In this way, the user can receive all the services from a plurality of the service providing webs by receiving verification from just one user verification device. In addition, it is not necessary for each of the service providing webs to perform user verification processing individually.

(5) In accordance with characteristics of the present invention, there is provided a service providing system, the system further comprising:

a charge-processing device for performing charge-processing to the user upon receipt of log information for charging a service charge,

wherein the user verification device transmits the log information to the charge-processing device in response to issuance of the access ticket.

In this way, it is not necessary for each of the service providing webs to perform charge-processing individually. Also, a highly dependable system with no probability of illegal use of the confidential information for the user can be provided because only the information for charging a service charge (such as credit card number and so on) is disclosed to the user verification device having a high reliability. Further, accurate amount of the service charge can be charged since the charge is performed simultaneous with the issuance of the access ticket. In addition, incorrect charge-processing can be prevented because the information for charging a service charge is provided by the user verification device in association with the issuance of the access ticket.

(6) Also, in accordance with characteristics of the present invention, there is provided a service providing system, the system further comprising:

a charge-processing device for performing charge-processing to the user upon receipt of log information for charging a service charge,

wherein the service providing web transmits the log information to the charge-processing device when a request for service accompanying the access ticket is received.

In this way, it is not necessary for each of the service providing webs to perform charge-processing individually. Also, a highly dependable system with no probability of illegal use of the confidential information for the user can be provided because only the information for charging a service charge (such as credit card number and so on) is disclosed to the user verification device having a high reliability. Further, accurate amount of the service charge can be charged since the charge is performed simultaneous with the issuance of the access ticket. In addition, incorrect charge-processing can be prevented because the information for charging a service charge is in association with the issuance of the access ticket.

(7) The service providing system according to the present invention is characterized in that the user verification device comprises a user-oriented recording part for storing service providing webs capable of being accessed by each user, and

wherein the user verification device generates a user-oriented menu in accordance with content recorded in the user-oriented recording part when the user verification means judges that user is a registrant and transmits the menu to the terminal device.

In this way, only the service in which the user being registered and usable can be displayed on the service terminal.

(9) In accordance with characteristics of the present invention, there is provided a user verification device capable of communicating with a user terminal device,

wherein the user verification device judges whether or not a user of the user terminal device is a registrant and transmits an access ticket for accessing a service providing web to the terminal upon receipt of designation of a desired service providing web when the user verification means judges that the user of the terminal is a registrant.

In this way, information for verification is provided to the user verification device and no such information is provided directly to the service providing web. The user verification device issues an access ticket allowing access to the service providing web after confirming the information for verification. Consequently, management of accessing with the web can be carried out without disclosing the information for verification.

(10) The user verification device according to the present invention is characterized in that the user verification device manages the information for verification for each of the service providing webs and controls issuance of the access ticket related to each of the service providing webs.

In this way, the system can be developed without awareness of the user verification device separately provided from service providing device to the user because management of the information is performed each of the service providing webs.

(11) Also, the user verification device according to the present invention is characterized in that the user verification device manages common information for verification in relation to a plurality of service providing webs and controls issuance of the access ticket related to each of the service providing webs.

In this way, the user can receive all the services from a plurality of the service providing webs by receiving verification from just one user verification device. In addition, it is not necessary for each of the service providing webs to perform user verification processing individually.

(12) Further, the user verification device according to the present invention is characterized in that the user verification device transmits log information for charging a service charge containing information on users to a charge-processing device which performs charge-processing in response to issuance of the access ticket.

In this way, it is not necessary for each of the service providing webs to perform charge-processing individually. Also, a highly dependable system with no probability of illegal use of the confidential information for the user can be provided because only the information for charging a service charge (such as credit card number and so on) is disclosed to the user verification device having a high reliability. Further, accurate amount of the service charge can be charged since the charge is performed simultaneous with the issuance of the access ticket.

(13) The user verification device according to the present invention is characterized in that the user verification device further comprising:

a user-oriented recording part for storing service providing webs capable of being accessed by each user, and

menu generating means for generating a user-oriented menu in accordance with content recorded in the user-oriented recording part when the user verification means judges that user is a registrant.

In this way, only the service in which the user being registered and usable can be displayed on the service terminal.

(14) Further, in accordance with characteristics of the present invention, there is provided a service providing device including one or a plurality of service providing webs, wherein the service providing web judges whether or not a request for service accompanies the access ticket upon receipt of the request for service from the terminal device and provides a service to the terminal device when the service providing web judges that the request for service accompanies the access ticket.

In this way, information for verification is provided to the user verification device and no such information is provided directly to the service providing web. The user verification device issues an access ticket allowing access to the service providing web after confirming the information for verification. Consequently, management of accessing with the web can be carried out without knowing the information for verification to the service provider.

(15) The service providing device according to the present invention is characterized in that the service providing web transmits log information for charging a service charge containing information on users to a charge-processing device which performs charge-processing when a request for service accompanying the access ticket is received.

In this way, it is not necessary for each of the service providing webs to perform charge-processing individually. Also, a highly dependable system with no probability of illegal use of the confidential information for the user can be provided because only the information for charging a service charge (such as credit card number and so on) is disclosed to the user verification device having a high reliability. Further, accurate amount of the service charge can be charged since the charge is performed simultaneous with the issuance of the access ticket. In addition, incorrect charge-processing can be prevented because the information for charging a service charge is provided by the user verification device in association with the issuance of the access ticket.

(16) In accordance with characteristics of the present invention, there is provided a terminal device for receiving a service from a service providing web, the terminal device capable of communicating with a user verification device and the service providing web through a network, wherein the terminal device performs following procedure; information for verification is transmitted to the user verification device, a service is requested to the service providing web with an access ticket obtained from the user verification device, and the service from the service providing web is received thereby.

In this way, access to the service providing web can be performed with the access ticket from the user verification device without directly providing the information for verification from the user terminal.

(17) Also, in accordance with characteristics of the present invention, there is provided a method of providing a service using terminal devices capable of communicating one another through a network, a user verification web, and a service providing web, the method comprising the steps of:

receiving an access ticket related to a desired service providing web after performing user verification procedure by accessing the user verification web from the terminal device when the terminal device receives the service from the service providing web;

accessing to the desired service providing web by the terminal device with the access ticket; and

providing the service to the terminal device by the service providing web after confirming accompany of the access ticket.

In this way, information for verification is provided to the user verification device and no such information is provided directly to the service providing web. The user verification device issues an access ticket allowing access to the service providing web after confirming the information for verification. Consequently, management of accessing with the web can be carried out without disclosing the information for verification.

In this invention, the term “terminal device” refers to a device for receiving a service(s), which can be connected to the Internet. In the embodiments described herein, mobile phones, and PCs function as the terminal device.

The term “network” in this invention refers to a network by which communication between equal or more than two devices is performed regardless of wired or wireless, not only an open network such as the Internet but also a closed one such as local area network (LAN).

The term “verifying information transmission means” corresponds to step S504 in FIG. 9 in an embodiment of the present invention.

The term “service requesting means” corresponds to step S506 in FIG. 9 in an embodiment of the present invention.

The term “user verification means” corresponds to step S603 in FIG. 9 in an embodiment of the present invention.

The term “access ticket issuing means” corresponds to step S605 in FIG. 9 in an embodiment of the present invention.

The term “access ticket judging means” corresponds to step S803 in FIG. 9 in an embodiment of the present invention.

The term “service providing means” corresponds to step S804 in FIG. 9 in an embodiment of the present invention.

The term “user-oriented recording part” in this invention refers to at least a part recording user information and capable of retrieving some of information under each user basis. In the embodiments described herein, a database for registration of users shown in FIG. 8 functions as the user-oriented recording part.

The term “menu generating means” corresponds to step S604 in FIG. 9 in an embodiment of the present invention.

The term “user information” in this invention refers to information related to users such as user's ID, user name, user's account number and so on.

The term “information for verification” in this invention refers to information used for verifying users, the information represents a concept including password, user's ID, user's phone number, user name and so on.

Other objects and features of the present invention will be more apparent to those skilled in the art on consideration of the accompanying drawings and following specification, in which are disclosed several exemplary embodiments of the present invention. It should be understood that variations, modifications and elimination of parts may be made therein as fall within the scope of the appended claims without departing from the spirit of the invention.

### BRIEF DESCRITION OF THE DRAWINGS

FIG. 1 is a schematic diagram of a conventional service providing system;

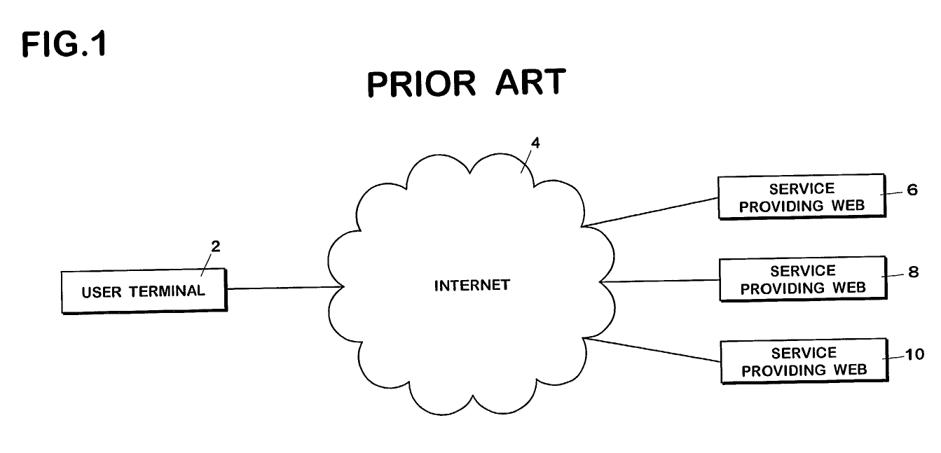

FIG. 2 is a schematic diagram of the service providing system in accordance with one embodiment of the present invention;

FIG. 3 is a block diagram of a user terminal configured as a personal computer (PC);

FIG. 4 is a block diagram of a user terminal configured as a mobile phone;

FIG. 5 is a flow diagram illustrating the processing for receiving an unrequited service;

FIGS. 6 A through 6G show images displayed on a liquid display of the mobile phone;

FIG. 7 is a flow diagram illustrating the processing for performing user registration;

FIG. 8 is an illustration of the contents of a database for registration of users;

FIG. 9 is a flow diagram illustrating the processing for receiving a pay-service;

FIGS. 10A and 10B show images displayed on a liquid display of the mobile phone;

FIG. 11 is an illustration of an access ticket;

FIG. 12 is an illustration of information on a log recording usage of a web page that is used for charging;

FIG. 13 is a flow diagram illustrating the processing for issuing an access ticket in another embodiment of the present invention;

FIG. 14 is a flow diagram illustrating the processing for issuing an access ticket in still another embodiment of the present invention;

FIG. 15 is an illustration of the contents of a database for registration of users in other embodiment.

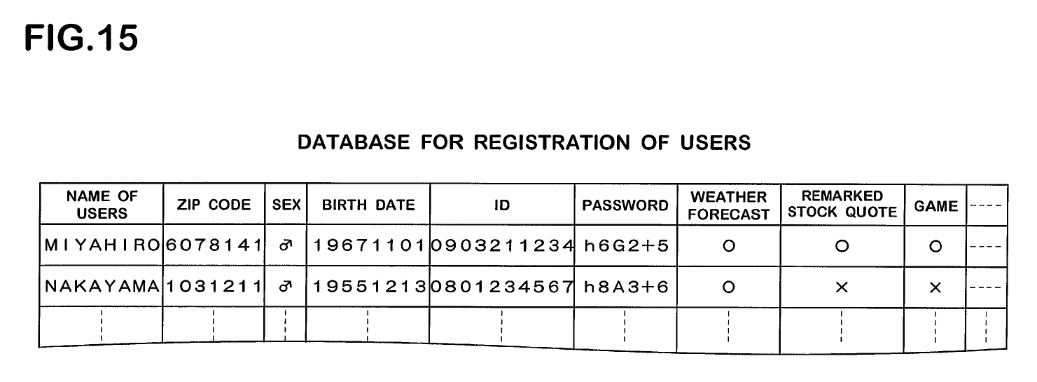

### DETAILED DESCRIPTION OF THE INVENTION

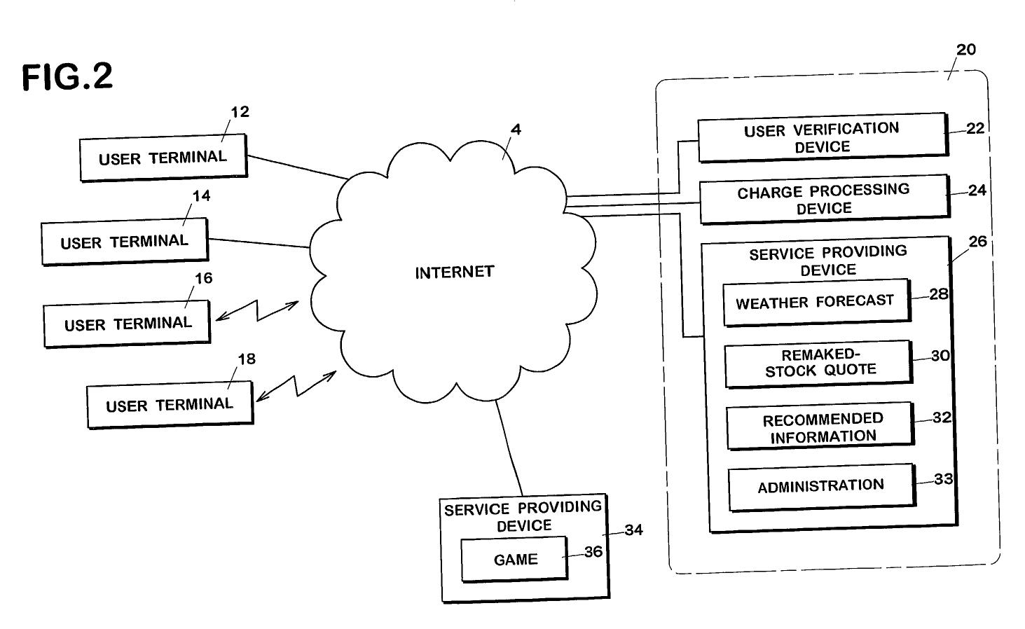

FIG. 2 shows a schematic diagram of the service providing system in accordance with one embodiment of the present invention. In this embodiment, user terminals 12, 14 are PCs capable of connecting the Internet 4. Other user terminals 16, 18 are mobile phones capable of accessing to the Internet. Connected to the Internet 4 is an administration center 20. It is preferred to own the administration center 20 by an organization involve a high public aspects such as a telecommunication carrier and a similar organization. The administration center 20 comprises a user verification device 22, a charge-processing device 24, and a service providing device 26. The service providing device 26 installed in the administration center 20 is a server so called a rental server, that is rented for a service provider(s) who wants to develop webs. In this embodiment, a variety of webs such as weather-forecast web 28, remarked-stock quote web 30, recommended information web 32, and administration web 33 are installed within the service providing device 26. In addition, another service providing device 34 is provided outside of the administration center 20 so as to connect to the Internet 4. Within the service providing device 34, a game web 36 is installed.

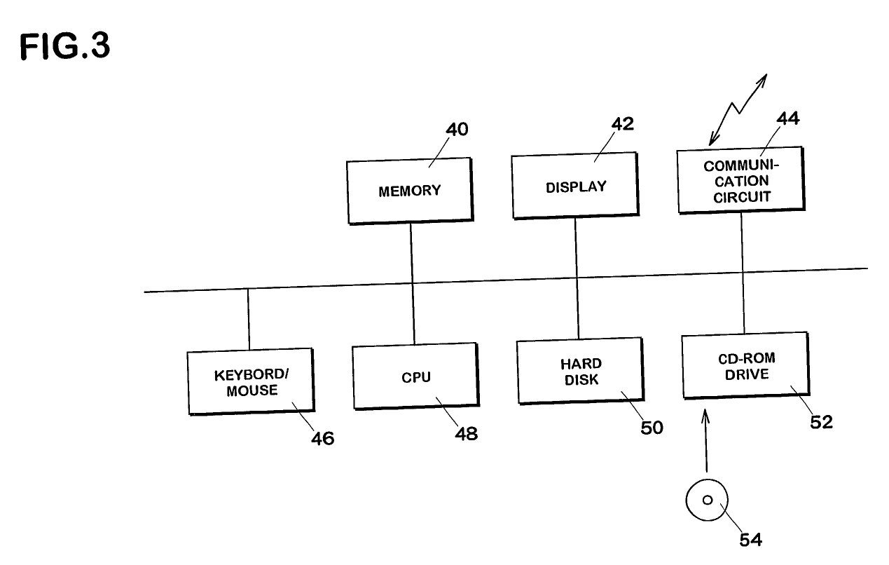

FIG. 3 shows a hardware structure of the user terminals 12 and 14. The user terminals 12 (14) comprises a memory 40, a display 42, a communication circuit 44, an input part such as key-board/mouse 46, a CPU 48, a hard disk (recording device) 50, a CD-ROM drive 52. Stored in the hard disk 50 are an operating system such as WINDOWS98™ by MICROSOFT™, a browser program to view webs. The browser program is placed on a Windows workstation server via the CD-ROM 54. The communication circuit 44 is a circuit for accessing the Internet 4.

Each of the user verification device 22, the charge-processing device 24, the service providing devices 26, 34 depicted in FIG. 2 have the same construction to the hardware structure shown in FIG. 3. However, in the user verification device 22, a user verification program is stored in the hard disk installed therein. A charge-processing program is stored in the hard disk of the charge-processing device 24. In the service providing devices 26, web server programs, for the weather forecast web 26, for the remarked stock quote web 30, and for the recommended information web, are stored in the hard disk thereof. In the service providing devices 34, a web server program for the game web 35 is stored in the hard disk thereof.

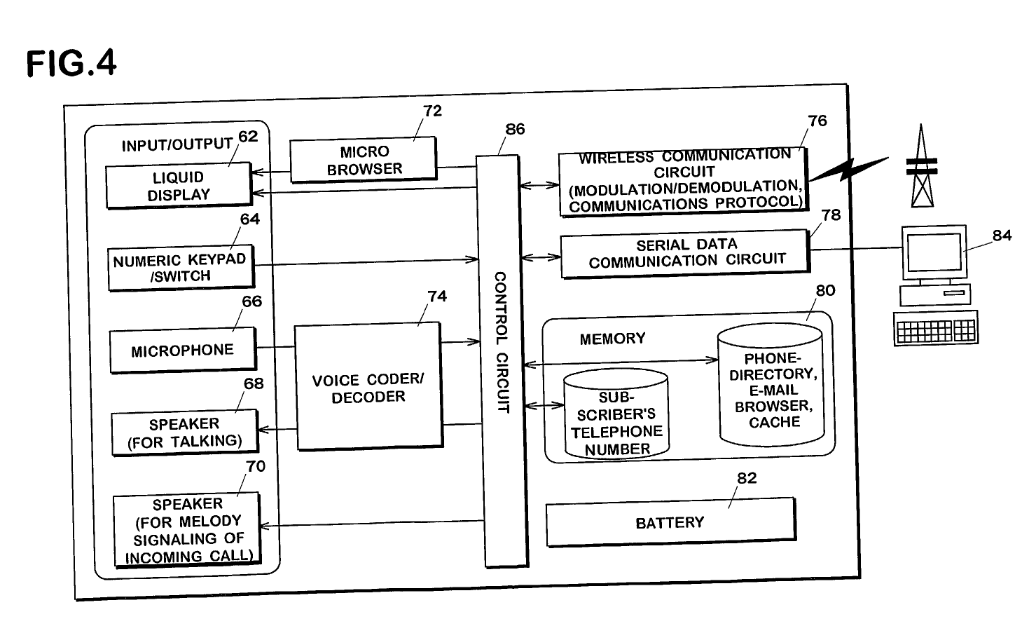

FIG. 4 is a block diagram of a user terminal 16 and 18 configured as a mobile phone. A liquid crystal display 62, a numeric keypad/switch 64, microphone 66, a speaker (for talking) 68, and another speaker (for melody signaling of incoming call) 70 are provided therein as input/output devices. A voice coder decoder 74 is a device used for encrypting the sounds inputted through the microphone 66 for transmission and for decrypting the audio signals received for outputting through via the speaker 68. A microbrowser 72 is a program stored in a recording device of the terminal and that is used for viewing web pages from the service providing webs. A wireless communication circuit 76 is a circuit for transmitting/receiving data or sounds via wireless communications. A serial data communication circuit 78 is a circuit for carrying out communication between a PC 84 located outside of the terminal. Stored in a memory 80 are the phone number of the subscriber himself/herself, and private phone directory. A control circuit 86 controls these circuits. Further, a battery 82 supplies electric power to the parts requiring the power.

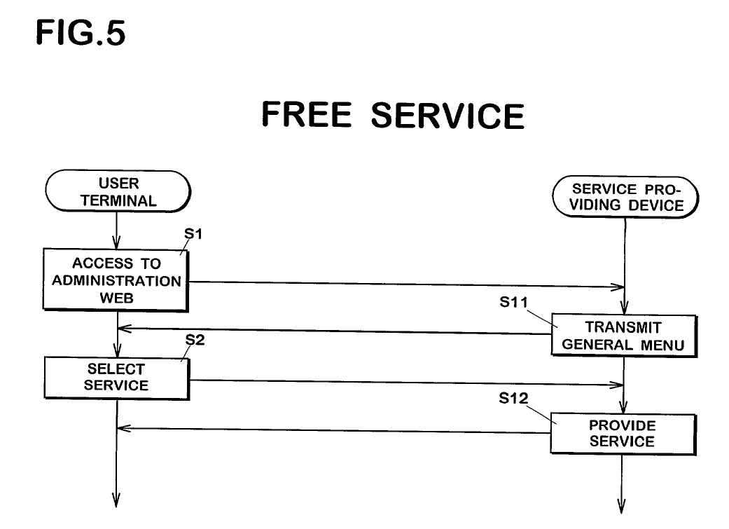

FIG. 5 is a flow diagram illustrating the processing for receiving an unrequited service via the user terminal 16 The chart illustrated in the left-hand side of the drawing is a flow chart of a microbrowser stored in the user terminal 16. The chart illustrated in the right-hand side of the drawing is a flow chart of a web server program stored in the service providing devices 34. In this embodiment, no access is performed to a web providing an unrequited service as shown in FIG. 5.

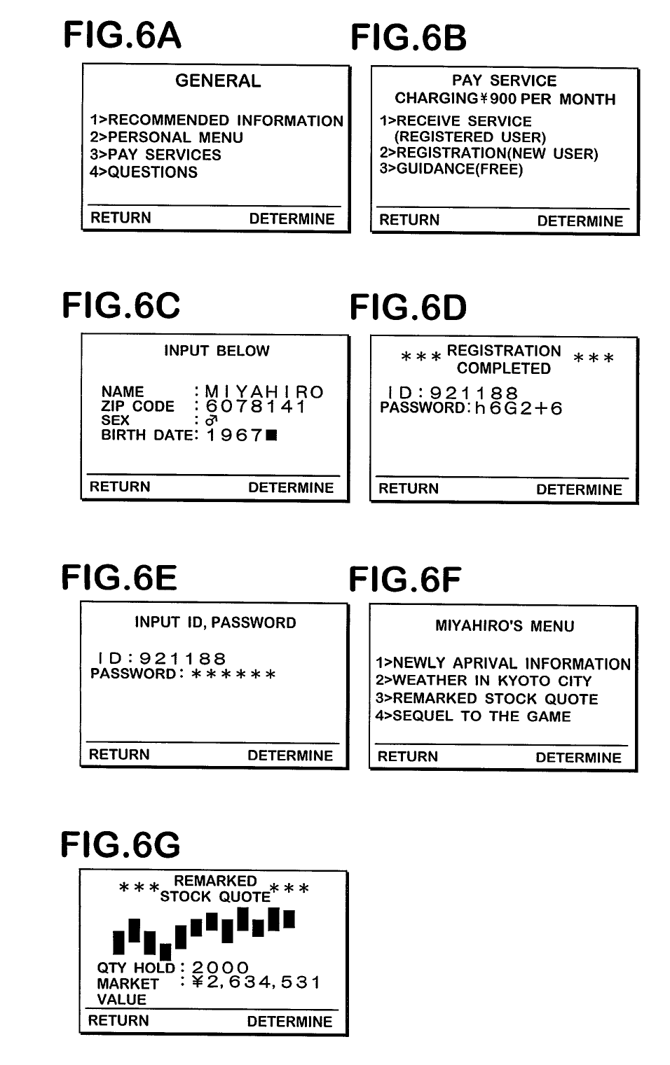

At first, the user accesses to the Internet 4 using the user terminal 16, and then accesses to the administration web 33 in the service providing device 26 (step S1 in FIG. 5). In response to the access, the administration web 33 transmits general menu shown in FIG. 6A. (step S11 of FIG. 5).

The general menu is displayed on the liquid crystal display 62 of the terminal. The user depresses “determination button” after selecting a display “recommended information” by operating the numeric keypad/switch 64 of the terminal 16 (step S2 of FIG. 5). The microbrowser installed in the terminal 16 accesses to the recommended information web 32 developed in the service providing device 26. In response to the access, the web server program of the recommended information web 32 transmits recommended information to the terminal 16 (step S12 of FIG. 5). On the display 62 of the terminal 16, the recommended information transmitted from the web 32 is displayed (not shown).

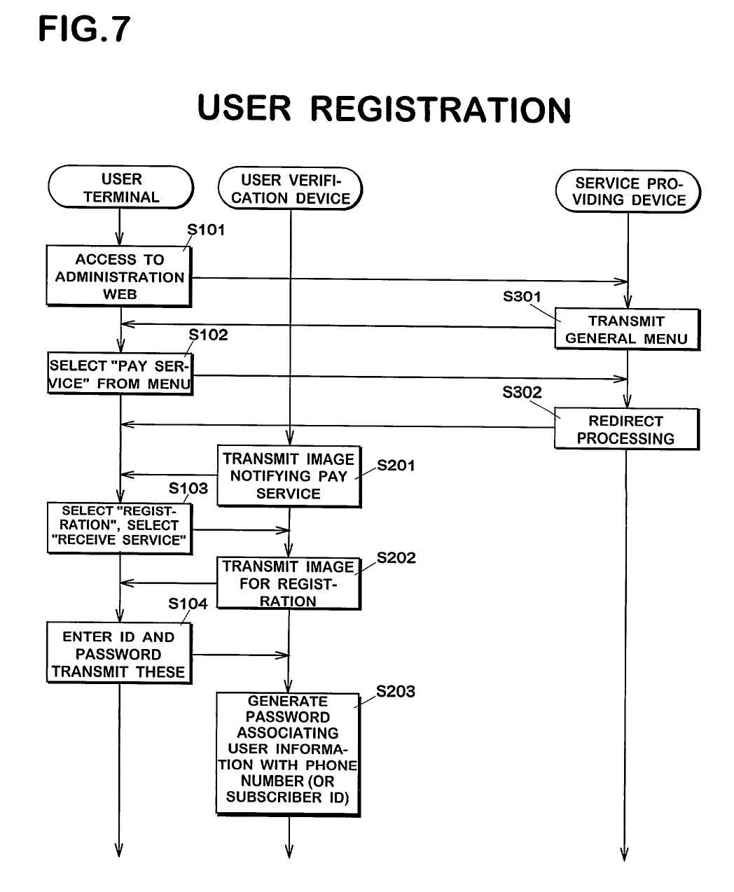

Subsequently, FIG. 7 illustrates the processing for performing user registration prior to requesting pay service from the terminal 16.

At first, the user accesses to the Internet 4 using the user terminal 16, and then accesses to the administration web 33 in the service providing device 26 (step S101 in FIG. 7). In response to the access, the administration web 33 transmits general menu shown in FIG. 6A. (step S301 of FIG. 7).

The general menu is displayed on the liquid crystal display 62 of the terminal. The user depresses “determination button” after selecting a display “toll information” by operating the numeric keypad/switch 64 of the terminal 16. In response to the depression, web server program of the administration web 33 in the service providing device 26 controls the microbrowser of the terminal 16 to change item to be viewed thereof to the user verification device 22 as a result of performing redirect processing (step S302 of FIG. 7). In this way, an image which notifies the user that the service to be retrieved is a pay service, is transmitted from the user verification device 22 to the microbrowser of the terminal 16 (step S201 of FIG. 7).

In this embodiment, since the item to be viewed are switched automatically using the redirect processing as described above, the item to be viewed being switched can be designated by controlling the processing of the web server program without changing HTML documents in the administration web 33.

Instead of performing the redirect processing, the user verification device 22 may be described in the HTML document of the administration web 33 as an item linked to the web server program.

FIG. 6B illustrates an image notifying pay service transmitted from the user verification device 22. The user depresses a “determination button” after selecting a display “registration (new user)” by operating the numeric keypad/switch 64 of the terminal 16. A list of webs that provide pay services is displayed so that a service to which the user try to register is selected and the “determination button” representing the selected service is depressed for registration. Here, it is assumed that a service providing web site “remarked-stock quote” is selected (step S103 of FIG. 7).

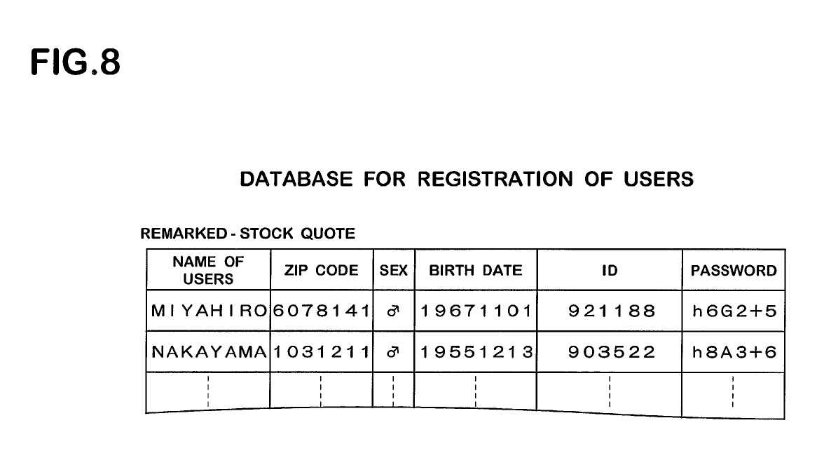

In response to the selection, the user verification device 22 transmits an image for registration depicted in FIG. 6C to the terminal 16. The user enters his/her name, zip code, sex, and birth date and so on by operating the numeric keypad/switch 64 of the terminal 16 and then depresses a “determination button”. The information thus entered is transmitted to the user verification device 22 (step S104 of FIG. 7). The user verification device 22 obtains the subscriber ID of the terminal 16 through the transmission and defines it as the use's ID. The subscriber ID is an identifier uniquely assigned to the subscriber by a communication common carrier such as KDDI (a company established with the merger of DDI CORPORATION, KDD Corporation and IDO CORPORATION on Oct. 1, 2000). The user's ID can automatically be obtained from the communication common carrier whenever the telephone line therebetween is connected. Further, the user verification device 22 generates a password, and the generated password is associated with the information on the user and stored in the hard disk. FIG. 8 is an illustration of the contents of a database for registration of users. In the database, information on users such as personal information of the registered users, their IDs, passwords and so on are stored therein. The database depicted in FIG. 8 is established for each of the service providing webs, and similar information to the above is recorded therein.

After recording these informations to the database, the user verification device 22 transmits an image representing completion of registration which indicates the ID and the password to the terminal 16 (step S203 of FIG. 7). FIG. 6D shows an image representing completion of registration displayed on the terminal 16.

Once the registration has been completed as described above, the registered user can receive the service provided from the remarked-stock quote web 30 by inputting the assigned password.

In the case of changing a web providing a desired service to another web (change in designation as a desired web to an undesired we, and vice versa.), the change of the desired web may be registered by accessing to the user verification device 22.

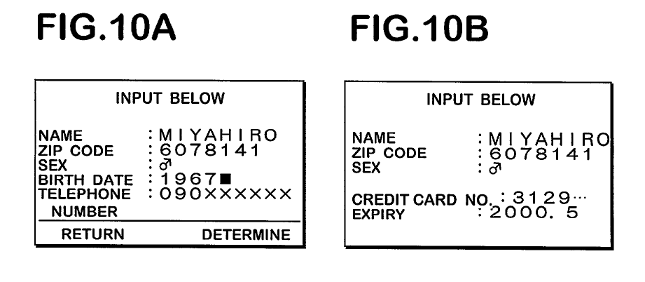

Above descriptions are made under an assumption that the user terminal 16 is a mobile phone. It is necessary for the user to enter his/her phone number and so on as an ID when a PC connected to the Internet (either of dial-up connection or continuous connection Internet service) is used as the user terminal 12 for registration. This is because the subscriber ID of the user terminal can not be obtained by the user verification device 22. The user verification device 22 transmits an image for registration depicted in FIG. 10A at step S202.

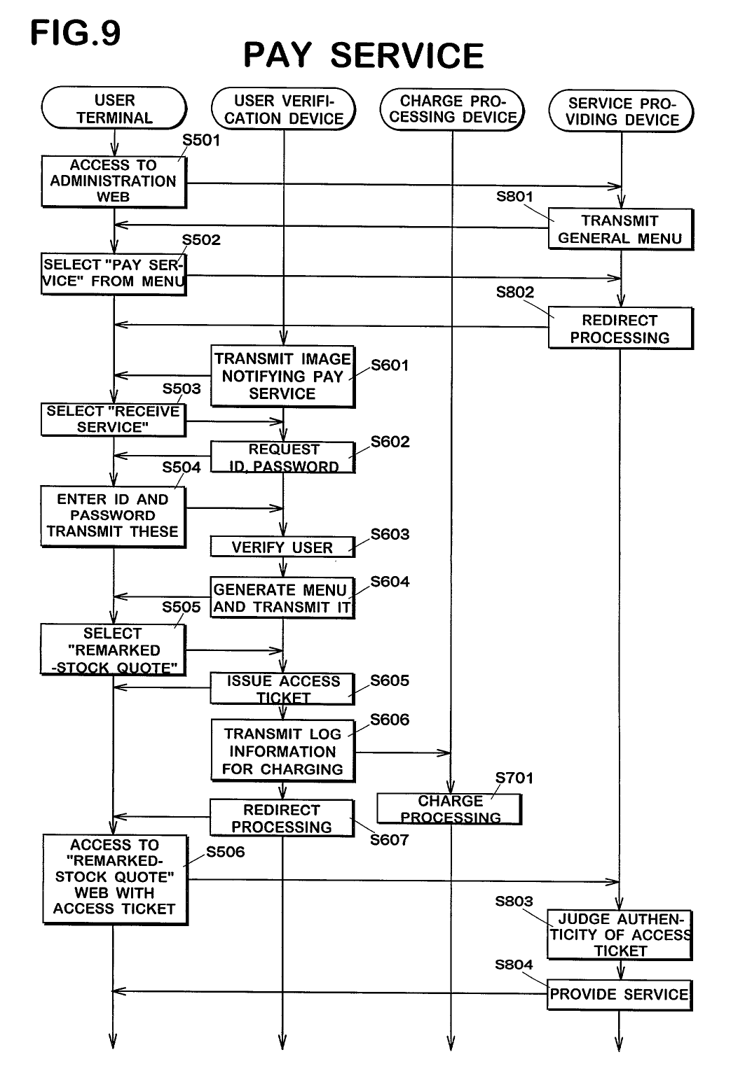

Next, the processing for receiving a pay-service is described in FIG. 9. Communications between the user verification device 22 and the user terminal 16 are performed by the web server program stored in the user verification device 22 and the microbrowser in the user terminal 16. Similarly, data communications between the service providing device 26 and the user terminal 16 are performed by web server programs stored in each of the webs installed in the service providing device 26 and the microbrowser in the user terminal 16. In addition, data communications between the user verification device 22 and the charge-processing device 24 are performed by encrypted e-mails or the like through the Internet.

A series of steps until an image notifying pay service to the user being transmitted to the terminal 16 from the user verification device 22 are similar to the steps described in FIG. 7.

In the notification image depicted in FIG. 6B, the user selects “receive the service” (step S503 of FIG. 9). In response to the selection, the user verification device 22 transmits an image that requests entering of ID and password shown in FIG. 6E. Its ID (subscriber ID) is automatically obtained when the terminal is a mobile phone. In this case, a column for entering ID in the image is automatically filled out and the user verification device 22 transmits the filled out image (see FIG. 6E) to the terminal 16.

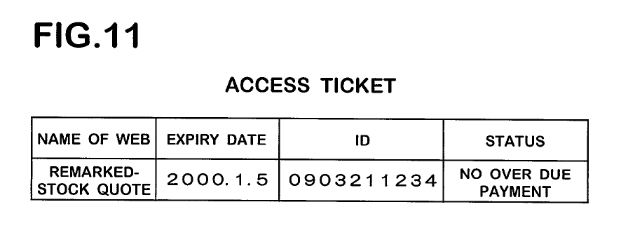

The user enters his/her password through the terminal 16 and the entered password is transmitted therefrom (step S504 of FIG. 9). The user verification device 22 judges whether or not the passwords transmitted agrees with the password registered in the database for registration of users (step S603 of FIG. 9). If not agreed, an image representing disagreement is sent back to the terminal. If they agree with each other, a web, which wish to subscribe by a user identified by his/her ID is selected with reference to the database, and a menu for the user is generated. The generated menu is transmitted to the terminal 16 (step S604 of FIG. 9). A user-oriented menu thus generated that is displayed on the terminal 16 is illustrated in FIG. GF The user selects one of the services on the menu and depresses “determination button” for the selected service (step S505 of FIG. 9). Here, it is assumed that a service providing “remarked-stock quote” is selected. In response to the selection, the user verification device 22 issues an access ticket and sends it to the terminal 16 (step S605 of FIG. 9). In the access ticket, name of the web, its expiration date, its ID, and the current status are described as depicted in FIG. 11. The name of the web is information (name of the web, web ID and so on) for specifying a web that can be viewed by using the ticket. The expiration date is a date until when the ticket is valid. The ID is an ID for the user. The current status is the status in payment of the user (one of no over due payment, overdue payment equal or less than XXXX yen, and overdue payment equal or more than XXXX yen). The access ticket is further transmitted to the terminal 16 under an encrypted format using secret key such as DES (Data Encryption Standard).

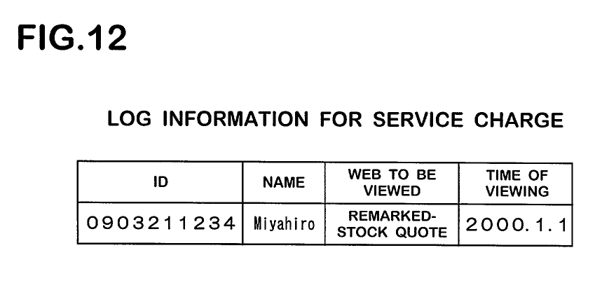

In addition, the user verification device 22 then transmits log information on visiting pay service for charging a service charge(s) through an e-mail (step S606 of FIG. 9). The log information contains an ID of the user, user's name, a web to be viewed, and date and time of viewing as depicted in FIG. 12.

The charge-processing device 24 calculates service charges in accordance with the log information and performs charge-processing (step S701 of FIG. 9). Since the subscriber ID is used as the ID of the user in this embodiment, both the subscriber ID and the calculated fees are transmitted to an administrative web (a device for settlement) owned by telecommunication carriers such as NTT, and KDDI and so on. In this way, these telecommunication carrier may collect the service fees together with telephone bills of the user. The service charges for the service provided by the web thus collected is paid to the owner of the administration center 20 by the telecommunication carrier and then paid to owner of the web from the administration center 20.

After transmitting the log information, the user verification device 22 makes the terminal 16 to access with the remarked-stock quote web 30 by using redirect functions (step S506 of FIG. 9). Since the process uses redirect functions, no additional input is required to the user. Subsequently, the terminal 16 transmits the access ticket obtained from the user verification device 22 to the remarked-stock quote web 30.

The remarked-stock quote web 30 in the service providing device 26 decrypts the code of the access ticket and judges the authenticity (expiry and so on) of the ticket (step S803 of FIG. 9). If the authenticity is verified, the web 30 provides the service provided therefrom (step S804 of FIG. 9). If the authenticity is not verified (e.g. outdated and the like), no service is provided therefrom. Access by a user who is in behind in payment for a certain amount may be rejected with reference to the current status of the ticket by the webs in the service providing device 26. When the access is rejected, a notice for not performing charge-processing must be transmitted to the charge-processing device 24. FIG. 6G is an image representing an accessed web site displayed on the terminal 16.

In this embodiment, the user verification device 22 performs processing for a plurality of user terminals.

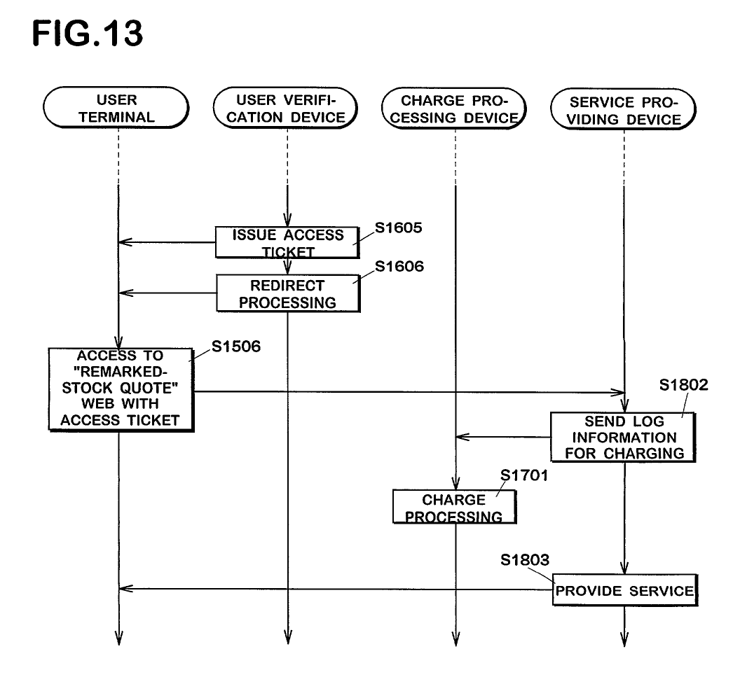

Although, the log information is transmitted from the user verification device 22 in the embodiment described above, the log information may be transmitted by a web of the service providing device 26 as depicted in FIG. 13 (step S1802 in FIG. 13). To do that, it is preferred to describe detailed information of the user such as ID, name of the user and so on in an access ticket.

In the embodiment described in above, databases for recording ID, password and so on are developed in each of the webs. A common database recording common information such as ID, password and so on can be developed for a plurality of webs for simplicity. In this way, just one each of ID and password can do for a plurality of service providing web sites so that management of these informations can be simplified.

Although, the subscriber ID is used as an ID of the user for user registration in the embodiment described above, phone number can be used as the ID of the user because the phone number can directly be obtained when a telecommunication carrier such as KDDI owns the administration center 20. Alternatively, the user may decide his/her ID by himself/herself and entering it. In that case, the self decided ID not agree with his/her phone number and the subscriber ID so that the self decided ID need to be associated with one of the phone number and the subscriber ID in order to collect the service fees together with telephone bills of the user. If necessary, appropriate information for the user registration may be provided by the user simultaneous with submission of an application for telephone subscription.

In the embodiment described above, the service fees are collected together with telephone bills of the usr, the fees may be settled by a credit card. In that case, credit card number, expiry date and so on should be entered during the user registration procedure as shown in FIG. 10B. The information thus entered is recorded in the database for user registration of the user verification device 22. In addition, these information are described on the log information when the log information is transmitted to the charge-processing device 24 from the user verification device 22 as shown in FIG. 9. The charge-processing device 24 transmits calculated fees and other information such as credit card number and so on to a device for settlement owned by a credit card company.

In the case of transmitting the log information to the charge-processing device 24 from the service providing device 26 as shown in FIG. 13, credit card number and expiry date are described on the access ticket. As a result, the service providing device 26 receiving the access ticket can transmit log information accompanying appropriate information such as credit card number and so on for settlement (see step S1802 of FIG. 13).

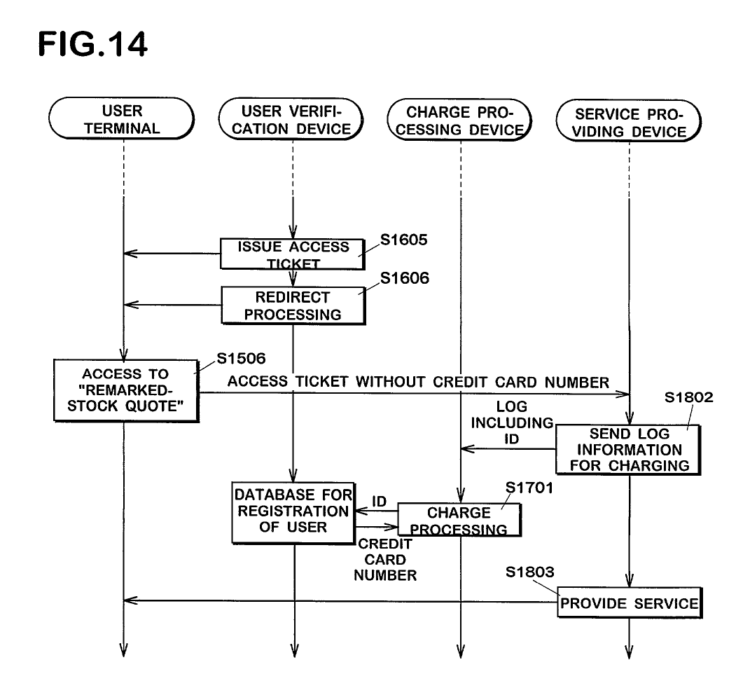

The method described above leads unexpected disclosure of the confidential information to the service providing web. In order to settle service fees without disclosing the confidential information, a procedure shown in FIG. 14 is preferred. The access ticket transmitted from the terminal 16 to a web in the service providing device 26 not include credit card number (step S1506 of FIG. 13). The web in the service providing device 26 generates log information on visiting pay service for charging a service charge(s) including the user ID and send the log information to the charge-processing device 24 (step S1802 of FIG. 13). The charge-processing device 24 then inquires for the credit card number and so on of the user with the user registration database. Subsequently, the charge-processing device 24 generates information for settlement which to be transmitted to the device for settlement in accordance with the confidential information.

There is no probability to use the credit card number illegally because the charge-processing device 24 is maintained by the administrator of a specific administration center. With the method shown in FIG. 14, the service fees can be settled by a credit card without disclosing the confidential information to the administrator of service providing webs.

Alternatively, the service fees may be settled by other monetary method (i.e. cyber-money). In that case, appropriate information for settling by cyber-money is obtained from the user during the user registration and the obtained data is stored in the user registration database. In addition, prepaid cards may settle the service charge.

Communications between the user verification device 22 and the charge-processing device 24 are performed by e-mails over the Internet in the above-described embodiment. The communications, however, may also be performed over a LAN (Local area network) connected therebetween. In addition, the user verification device 22 and the charge-processing device 24 may be composed of one computer.

In the embodiment described above, the service providing webs are developed in each of the rented webs provided in the service providing device 26 managed by the owner of the administration center 20. However, the embodiment can be applied to a service providing web (the game web 36 in FIG. 2) developed in the service providing device 34 (see FIG. 2) located at a position outside of the administration center 20.

Name, zip code, sex, birth date are need to be entered in the image depicted in FIG. 6C. Other information such as mail address, home telephone number (if the user terminal is a mobile phone), fax number, E-mail address, occupation, personal interests and so on may be required to enter. Too much information to be entered put a heavy burden to the user. Especially, when the user uses a mobile phone, entering these informations in alphabetic characters and Kanji (Chinese) characters is hard to do so that it is preferred to select information can be entered in numeric as item(s) to be entered.

In FIG. 12, ID of the user, user's name, a web to be viewed, and date and time of viewing are listed as the log information. Alternatively, a code of surrogate services for collecting the service charges, a code of service provider, item code, URL, IP address, time of requesting services, time of finishing services, completion of the services (either of complete or incomplete) may be used as the log information.

Furthermore, all or a part of the following information such as ID of the user, a code of surrogate services for collecting the service charges, a code of service provider, item code, quantity of item, unit prices of item, amount, time of requesting services, time of finishing services, completion of the services (either of complete or incomplete), a code of a user log generating device and so on can also be used as information for settlement which to be transmitted to the device for settlement from the charge-processing device 24.

In the embodiment described above, verification of the user is performed with password, and ID, any other method such as finger print, voice pattern, digital certificate and so on may be used for user verification.

Also, in the embodiments described above, a system performing both user verification processing and charge-processing have been described, the system can be a system which performs just user verification processing.

While the embodiments of the present invention, as disclosed herein, constitute preferred forms, it is to be understood that each term was used as illustrative and not restrictive, and can be changed within the scope of the claims without departing from the scope and spirit of the invention.

What is claimed is:

1. A service providing system comprising terminal devices capable of communicating one another through a network, a user verification device, and a service providing device including at least one service providing web,
wherein each of the terminal devices comprises;
verifying information transmission means for transmitting information for verification to the user verification device, and
service requesting means for requesting a service to the service providing web with an access ticket obtained from the user verification device,
and wherein the user verification device comprises;
user verification means for judging whether or not user of a terminal device is a registrant upon receipt of the information for verification from the terminal device, and
access ticket issuing means for transmitting an access ticket for accessing a service providing web to the terminal upon receipt of designation of a desired service providing web when the user verification means judges that the user of the terminal is a registrant, and
wherein the service providing web comprises;
access ticket judging means for judging whether or not a request for service accompanies the access ticket upon receipt of the request for service from the terminal device, and
service providing means for providing a service to the terminal device when the access ticket judging means judges that the request for service accompanies the access ticket, and
wherein following procedure is performed when the terminal device receives the service from the service providing web;
the information for verification is transmitted by the verifying information transmission means of the terminal device,
the user verification means of the user verification device judges whether or not the user of the terminal device is a registrant in accordance with the information for verification, and the access ticket for the service providing web is transmitted to the terminal device when the user is a registrant,
the service requesting means of the terminal device requests the service to the service providing web with the access ticket, and
the service providing web provides the service after confirming accompany of the access ticket.

2. A service providing system for providing a service to a user terminal device through a network, the system comprising a user verification device and a service providing device including at least one service providing web,
wherein the user verification device judges whether or not a user of the user terminal device is a registrant and transmits an access ticket for accessing a service providing web to the terminal upon receipt of designation of a desired service providing web when the user verification means judges that the user of the terminal is a registrant, and
wherein the service providing web judges whether or not a request for service accompanies the access ticket upon receipt of the request for service from the terminal device and provides a service to the terminal device when the service providing web judges that the request for service accompanies the access ticket.

3. The service providing system of claim 2, wherein the user verification device manages the information for verification for each of the service providing webs and controls issuance of the access ticket related to each of the service providing webs.

4. The service providing system of claim 2, wherein the user verification device manages common information for verification in relation to a plurality of service providing webs and controls issuance of the access ticket related to each of the service providing webs.

5. The service providing system of claim 2, wherein the system further comprising:
a charge-processing device for performing charge-processing to the user upon receipt of log information for charging a service charge,
wherein the user verification device transmits the log information to the charge-processing device in response to issuance of the access ticket.

6. The service providing system of claim 2, the system further comprising:
a charge-processing device for performing charge-processing to the user upon receipt of log information for charging a service charge,
wherein the service providing web transmits the log information to the charge-processing device when a request for service accompanying the access ticket is received.

7. The service providing system of claim 2, wherein the user verification device comprises a user-oriented recording part for storing service providing webs capable of being accessed by each user, and
wherein the user verification device generates a user-oriented menu in accordance with content recorded in the user-oriented recording part when the user verification means judges that user is a registrant and transmits the menu to the terminal device.

8. The service providing system of claim 2, wherein the user verification device and the charge-processing device are composed of one computer.

9. A user verification device capable of communicating with a user terminal device,
wherein the user verification device judges whether or not a user of the user terminal device is a registrant and transmits an access ticket for accessing a service providing web to the terminal upon receipt of designation of a desired service providing web when the user verification means judges that the user of the terminal is a registrant.

10. The user verification device of claim 9, wherein the user verification device manages the information for verification for each of the service providing webs and controls issuance of the access ticket related to each of the service providing webs.

11. The user verification device of claim 9, wherein the user verification device manages common information for verification in relation to a plurality of service providing webs and controls issuance of the access ticket related to each of the service providing webs.

12. The user verification device of claim 11, wherein the user verification device transmits log information for charging a service charge containing information on users to a charge-processing device which performs charge-processing in response to issuance of the access ticket.

13. The user verification device of claim 9, the system further comprising:
a user-oriented recording part for storing service providing webs capable of being access ed by each user,
wherein the user verification device generates a user-oriented menu in accordance with content recorded in the user-oriented recording part when the user verification means judges that user is a registrant and transmits the generated menu to the user terminal device.

14. A service providing device including one or a plurality of service providing webs, wherein the service providing web judges whether or not a request for service accompanies the access ticket upon receipt of the request for service from the terminal device and provides a service to the terminal device when the service providing web judges that the request for service accompanies the access ticket.

15. The service providing device of claim 14, wherein the service providing web transmits log information for charging a service charge containing information on users to a charge-processing device which performs charge-processing when a request for service accompanying the access ticket is received.

16. A terminal device for receiving a service from a service providing web, the terminal device capable of communicating with a user verification device and the service providing web through a network, wherein the terminal device performs following procedure; information for verification is transmitted to the user verification device, a service is requested to the service providing web with an access ticket obtained from the user verification device, and the service from the service providing web is received thereby.

17. A method of providing a service using terminal devices capable of communicating one another through a network, a user verification web, and a service providing web, the method comprising the steps of:
receiving an access ticket related to a desired service providing web after performing user verification procedure by accessing the user verification web from the terminal device when the terminal device receives the service from the service providing web;
accessing to the desired service providing web by the terminal device with the access ticket; and
providing the service to the terminal device by the service providing web after confirming accompany of the access ticket.
